(19) United States
(12) Patent Application Publication
(10) Pub. No.: US 2009/0162148 A1
(43) Pub. Date: Jun. 25, 2009

(54) Feed Device for Conveying a Powdery Medium from a Powder Container into a Powder Conduit

(75) Inventor: Hans G. Platsch, Stuttgart (DE)

Correspondence Address: LEMPIA BRAIDWOOD LLC, 223 W. JACKSON BLVD., SUITE 620, CHICAGO, IL, 60606, US

(73) Assignee: Platsch GmbH & Co. KG, Stuttgart (DE)

(21) Appl. No.: 12/123,785

(22) Filed: May 20, 2008

(30) Foreign Application Priority Data
Dec. 23, 2007 (DE) 10 2007 063 534.8

(51) Int. Cl. B65G 51/36

(52) U.S. Cl. 406/28

(57) ABSTRACT

A feed device for conveying a powdery medium from a powder container into a powder conduit is specified and has a powder channel which connects the powder container and the powder conduit. The powder channel also, in a working position, is arranged with a vertical component of the axis of the powder channel above a charge end of the powder conduit. The powder channel has a joint unit with a charge joint part, to which the powder container is connected detachably in a sealed manner, and a delivery joint part for connecting the powder channel in a sealed manner to the charge end of the powder conduit. Displacement travel of the joint unit is sufficiently large for a filling level of the powder container to be located below an opening of the powder container in a lowered exchange position.

### RELATED APPLICATION DATA

This patent is related to and claims priority benefit under 35 U.S.C. §119(a) of prior filed German patent application no. 10 2007 063 534.8, which was filed on Dec. 23, 2007, and which is incorporated herein by reference in its entirety.

### BACKGROUND OF THE DISCLOSURE

1. Field of the Disclosure

The present disclosure is generally directed to material feeding devices, and more particularly to a feed device for conveying a powdery medium from a powder container into a powder conduit.

2. Description of Related Art

Feed devices of this type are used, for example, in metering devices of powder-coating installations in order to fill a reservoir with powder from a mobile exchangeable powder container. For this purpose, known feed devices have an open funnel into which the powder from the powder container is poured and from where it reaches the powder conduit. In order to ensure that the powder falls into the funnel, the opening of the powder container must be maintained precisely above the funnel. This is frequently difficult because the reservoir of the metering device is often arranged in confined spatial conditions and has difficult access. Moreover, the powder spreads dust into the environment while being poured into the open funnel. Furthermore, the reservoir is essential in this case, since otherwise the exchangeable powder container would need to be held above the funnel throughout the metering.

### SUMMARY OF THE DISCLOSURE

It is the object of the present invention to develop a feed device according to the preamble of Claim 1 in such a way that the powdery medium is transferred from the powder container into the powder conduit in a simple, reliable and dust-free manner.

This object is achieved according to the invention by a feed device with the features specified in Claim 1.

According to the invention the feed device has a joint part comprising a charge joint part and a delivery joint part. The powder container is connectable to the charge joint part. The delivery joint part is connectable to the powder conduit. The charge joint part is rotatable and/or swivellable with respect to the delivery joint part from a working position of the feed device to a container-exchange position and back.

In the exchange position the inlet opening of the charge joint part faces downwards, so that the powder container can be installed on the charge joint part from below, with its container opening oriented upwardly, with no powdery medium falling out of the powder container.

In order to charge the powder conduit, the powder container can be swivelled or rotated with the charge joint part to the working position, so that its container opening faces downwards towards the powder conduit. In the working position the charge joint part and the delivery joint part are oriented with respect to one another in such a way that the powdery medium can fall through the powder channel into the powder conduit, which powder channel passes through the charge joint part and the delivery joint part, or is connected to the latter.

In a development according to Claim 2, a blocking means in the powder channel is opened upon switching from the exchange position to the working position, or as a result of a subsequent rotary or swivelling movement of the charge joint part relative to the delivery joint part. The blocking means closes the powder channel in the exchange position and during the operation of rotating or swivelling the powder container from the exchange position to the working position. In this way, powdery medium cannot escape from the powder container or the powder channel while the latter is not connected in a sealed manner to the delivery joint part and therefore to the powder conduit. In this way, the powder container is connected simply and reliably to the powder conduit via the joint unit during delivery of the powder. In addition, the sealed connection of the container opening of the powder container to the inlet opening prevents powder dust from escaping into the environment during the filling operation.

Because of the sealed connection between powder container and powder conduit, a separate reservoir for the powdery medium can be dispensed with. Furthermore, in particular during a powder exchange, a simple and quick exchange of the powder is possible without the need to empty and clean a stationary reservoir.

So that the powdery medium flows more easily from the powder container, according to Claim 3 the powder container may taper inwards towards the container opening, in particular conically, in particular in a bottle-shaped configuration.

Furthermore, according to Claim 4, the powder channel may be oriented substantially vertically in the working position, so that the powder falls through the powder channel through gravity, as far as possible without adhering to the walls of the powder channel.

According to Claim 5, the powder container is preferably connectable simply and reliably to the charge joint part via a plug-in connection, a screw connection or a bayonet connection.

According to Claim 6, the blocking means, in particular a shut-off tap, may preferably include a plug which, for opening and closing the blocking means, is mounted rotatably about its axis of rotation in a tap housing, and the plug may have a through-passage which extends in a diametrical direction between two of its circumferential sides. In this way a robust blocking means which is simple and reliable in operation can be produced.

In a further advantageous embodiment according to Claim 7, through space-saving rotation of the charge joint part and of the powder container fastened thereto about the preferably vertical axis of rotation, the plug is rotated about the preferably horizontal axis of rotation in order to actuate the blocking means.

According to Claim 8, the plug, acting as the charge joint part, may form the joint part together with the tap housing, acting as the delivery joint part. In this way, the blocking means is opened simply by swivelling the powder container from the exchange position to the working position, without the need for separate opening to take place, or the need for an additional movement-redirection device.

In order to improve the flow behaviour of the powdery medium and to prevent powdery medium from clogging the container opening and/or the powder channel according to Claim 9 the feed device includes a device for fluidizing the powdery medium in the powder container.

This fluidizing device preferably comprises a fluidizing gas supply leading into the interior of the powder container, and preferably also a fluidizing gas discharge means, in particular comprising a suction lance which leads out of the powder container.

In addition, according to Claim 10 a sensor may be arranged in the powder channel, with which sensor it can be simply detected when powdery medium is no longer in the powder channel. This is the case, for example, when the powder container is empty or the opening of the powder container is clogged.

With the development according to Claim 11, mechanical fluidizing of the powder in the powder channel is obtained, so that said channel is not clogged and powder residues flow away reliably.

### BRIEF DESCRIPTION OF THE DRAWINGS

Further advantages, features and details of the invention are apparent from the following description, in which exemplary embodiments of the invention are explained in more detail with reference to the drawings, in which:

FIG. 1 shows a longitudinal section through a first exemplary embodiment of a powder feed device;

FIG. 2 shows schematically an exploded representation of a second exemplary embodiment of a feed device;

FIG. 3 is a side view of the feed device of FIG. 2;

FIG. 4 is a top view of the feed device according to FIGS. 2 and 3;

FIG. 5 shows a longitudinal section through the feed device from FIGS. 2 to 4 along a section line V-V from FIG. 3;

FIG. 6 shows a longitudinal section through the feed device according to FIGS. 3 to 5 along the section line VI-VI of FIG. 4;

FIG. 7 shows the feed device according to FIGS. 2 to 6 which is shown fixed to a vertical wall in a container-exchange position;

FIG. 8 shows the feed device according to FIGS. 2 to 7 in an intermediate position between the container-exchange position and a working position shown in FIG. 9; and

FIG. 9 shows the feed device according to FIGS. 2 to 8 in a working position in which powder is being delivered into the powder conduit.

### DETAILED DESCRIPTION OF THE DISCLOSURE

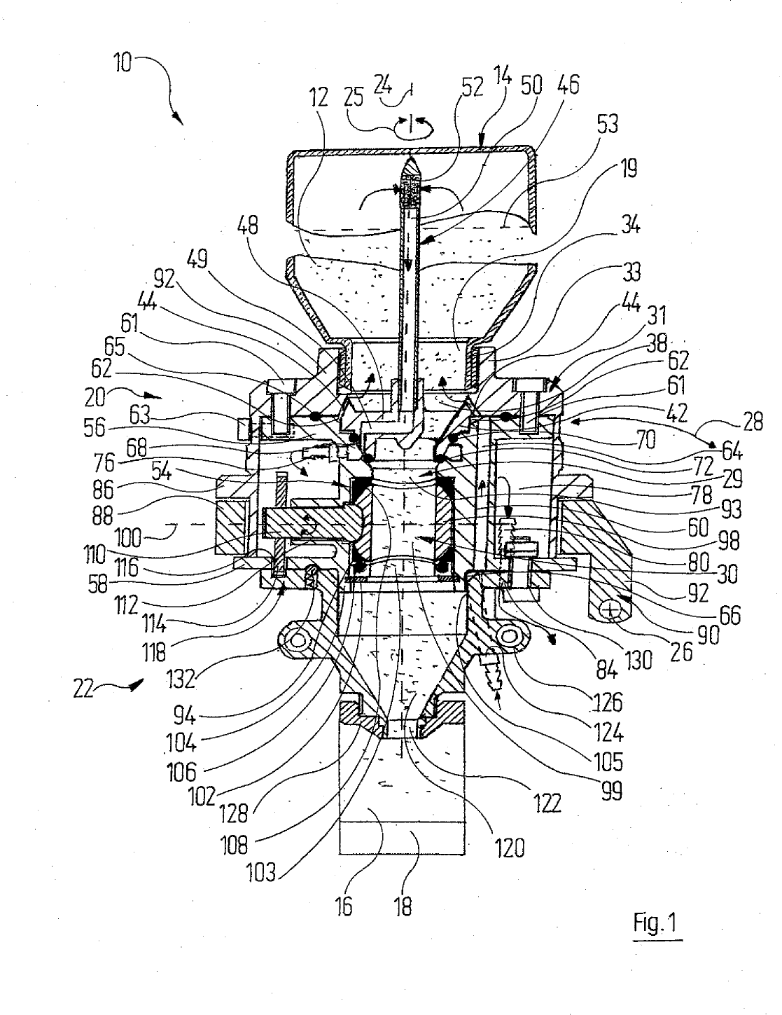

FIG. 1 shows a first exemplary embodiment of a feed device, denoted as a whole by reference numeral 10, which is used for conveying powder 12 from a powder bottle 14 into a powder conduit 16. The powder conduit 16 forms at the same time an intermediate buffer for the powder 12.

The powder conduit 16 leads to a metering device 18 of a powder metering apparatus (not shown).

The powder conduit 16 may also not be configured as an intermediate buffer (small cross-section and short). In this case the powder bottle 12 is itself the buffer. This has the advantage that a change of powder type can be carried out simply, without the need to empty an intermediate buffer.

FIG. 1 shows the feed device 10 in a working position, in which the powder bottle 14 is located above the powder conduit 16 with its container opening 19 oriented downwardly.

The feed device 10 includes a charge joint part 20, at the top in FIG. 1, and a delivery joint part 22, at the bottom in FIG. 1. These form together a joint unit delimiting a powder channel.

The charge joint part 20 is rotatable in the feed device, together with the powder bottle 14 attached thereto, relative to the delivery joint part 22, about an axis of rotation 24 of the bottle, vertical in FIG. 1, in the direction of a double arrow 25 (direction of rotation of bottle).

In addition, the charge joint part 20 is swivellable with the powder bottle 14 about a horizontal swivel axis 26 with reference to the delivery joint part 20, in the direction of an arrow 28 (swivelling direction), from a working position to a container-exchange position of the feed device 10.

In the exchange position (not shown) the charge joint part 20 with the powder bottle 14 is located beside the delivery joint part 22. The container opening 19 is oriented upwardly, so that powder 12 cannot be spilt when the powder bottle 14 is attached to the charge joint part 20.

In the working position a powder channel, denoted as a whole by reference numeral 29, passes through the charge joint part 20 and the delivery joint part 22 vertically and coaxially with the axis of rotation 24 of the bottle.

A shut-off tap 30, explained in more detail below, is located in the powder channel 29. The shut-off tap 30 is actuated by rotation of the charge joint part 20 relative to the delivery joint part 22 about the axis of rotation 24 of the bottle.

The charge joint part 20 comprises a cylindrical, bowl-like, downwardly open container-attachment part 31 with a base 32 located at the top in the drawing. The upper side of the base 32 carries an attachment socket 33 the inner face of which has an internal screw thread into which a neck 34 of the powder bottle 14 is screwed by means of a corresponding external thread.

The neck 34 has at its free end, at the bottom in FIG. 1, a container opening 19 of the powder bottle 14 which is oriented towards the charge joint part 20.

The powder bottle 14 tapers conically towards the neck 34, so that the powder 12 can better flow out of the powder bottle 14.

A continuous inlet section 38 of the powder channel 29 is located at the centre of the attachment part 31.

On the side facing away from the attachment socket 33, a funnel section 42, tapering inwards downwardly and oriented towards the interior of the attachment part 31, is moulded integrally with the latter, the inner face of which funnel section 42 defines the inlet opening 38.

A multiplicity of fluidizing gas channels 44 run with a radial component through the upper end of the funnel 42 to the lower end of the powder bottle 14.

The fluidizing gas channels 44 form part of a fluidizing arrangement, denoted as a whole by reference numeral 46 and explained in more detail below, for fluidizing the powder 12 contained in the powder bottle 14 by means of fluidizing gas, preferably compressed air.

In addition, an arm of an L-shaped lance carrier 48, disposed radially with respect to the axis of rotation 24 of the bottle, is moulded integrally with the inside of the funnel 42. The other arm of the lance carrier 48 is disposed coaxially with the axis of rotation 24 of the bottle, its free end being oriented towards the powder bottle 14.

An extraction channel section 49 of the fluidizing arrangement 46, which extraction channel section 49 runs with multiple angles from the lower end to the upper end of the lance carrier 48, is disposed inside the lance carrier 48.

The underside of the elbow in the lance carrier 48 has a conically tapering configuration, improving the flow of the powder 12 moving past.

A suction lance 50 of the fluidizing arrangement 46 is fitted into the upper end of the lance carrier 48 in the extraction channel section 49. The suction lance 50 may also be screwed into the extraction channel section 49.

At its end oriented away from the lance arm 48, the suction lance 50 has an inlet opening with a filter 52. The filter 52 is permeable to the fluidizing gas, but holds back the powder 12. Powder 12 cannot therefore reach the interior of the suction lance 50 and be extracted with the fluidizing gas during the fluidizing.

The free end of the suction lance 50 oriented away from the lance carrier 48 also tapers conically inwards in order to improve the flow of the powder 12. In addition, insertion of the suction lance 50 into the powder bottle 14 filled with powder 12 is facilitated thereby.

The suction lance 50 extends almost to the base of the powder bottle 14. In the working position of the feed device 10 shown in FIG. 1, the filter 52 is located above a filling line 53 for the powder 12.

The filling line 53 is indicated by a broken line in FIG. 1. Its position depends on the orientation of the powder bottle 14. In the exchange position of the powder bottle, obtained by swivelling said bottle downwards, the filling line 53 is located somewhat below the neck 34 when the powder bottle 14 is fill.

A middle housing part 54 of the feed device is located below the attachment part 31.

The housing part 54 has a disc-shaped upper mounting plate 56 and a likewise disc-shaped lower cover plate 58, which are disposed parallel to one another and parallel to the base of the attachment part 31, that is, perpendicular to the axis of rotation 24 of the bottle.

The mounting plate 56 and the cover plate 58 are connected in one piece, via a substantially cylindrical tap housing part 60 coaxial with the axis of rotation 24 of the bottle, to form the housing part 54.

The external contour of the tap housing part 60 may be, for example, cuboidal, instead of cylindrical, or may have an elliptical cross section.

The external diameter of the mounting plate 56 corresponds to the diameter of the interior of the attachment part 31. The external diameter of the cover plate 58 is larger than the external diameter of the attachment part 31.

The axial dimensions of the tap housing part 60 and of the mounting plate 56 are such that the cover plate 58 rests in a sealed manner against the free edge of the outer attachment part 31.

The mounting plate 56 is screwed in a sealed manner to the base 32 of the attachment part 31 by means of screws 61 disposed parallel to the axis of rotation 24 of the bottle and a screw 63 disposed radially with respect to said axis of rotation 24.

A sealing ring 65 is arranged between the surfaces of the base 32 and of the mounting plate 56 oriented towards one another. The sealing ring 65 surrounds the funnel section 42. It is located radially inside the screws 61.

The upper end of the middle housing part 54 has a receptacle, not denoted specifically, for the funnel section 42 of the attachment part 31, which receptacle extends into the tap housing part 60.

The funnel receptacle is substantially complementary to the external surface of the funnel section 42. The edge of the funnel receptacle oriented away from the tap housing part 60 is disposed obliquely and forms in that location, with the outer peripheral face of the funnel section 42, a continuous annular inlet chamber 62 for the fluidizing gas. The fluidizing gas channels 44 start from the annular inlet chamber 62.

An axial fluidizing gas feed channel 64 runs from the annular inlet chamber 62 parallel to the axis of rotation 24 of the bottle through the housing part 54 to another, lower annular inlet chamber 66.

The annular inlet chamber 66 is delimited continuously on one side by the region of the cover plate 58 having the fluidizing gas supply channel 64, so that it is connected to the fluidizing gas supply channel 64 in every rotational position of the charge joint part 20 relative to the delivery joint part 22.

In addition, an annular outlet chamber 68 for used fluidizing gas, continuously open to the funnel section 42, borders the funnel receptacle of the housing part 54.

The annular outlet chamber 68 is connected to the extraction channel section 49 of the lance carrier 48.

The annular outlet chamber 68 is sealed on both sides in the radial direction with respect to the funnel section 42 by respective O-rings 70, 72.

An outlet tube 76 of the fluidizing arrangement 46 passes through the peripheral wall of the housing part 54 and connects the annular outlet chamber 68 to a large annular chamber 78 in the housing part 54.

The large annular chamber 78 is delimited by the inner peripheral face of the attachment part 31, the outer peripheral face of the housing part 60 and the surfaces, facing towards one another, of the mounting plate 56 and of the cover plate 58. The fluidizing gas discharged from the powder bottle 14 flows through the large annular chamber 78.

The large annular chamber 78 is connected to the environment via a further outlet tube 80. The outlet tube 80 passes through the cover plate 58 parallel to the axis of rotation 24 of the bottle. It communicates with a continuous fluidizing gas discharge channel 84, leading outwardly to the environment, which passes through a substantially flat, circular disc part 118 of the delivery joint part 22.

In the working position, the disc part 118 is disposed parallel to the mounting plate 58 and rests against same in a planar manner.

The fluidizing gas discharge channel 84 extends along a circular line in the disc part 118, the centre of which circular line lies on the axis of rotation 24 of the bottle. In this way the outlet tube 80 opens at some point into the fluidizing gas discharge channel 84 in any rotational position of the charge joint part 20 with respect to the delivery joint part 22, so that an open connection to the environment always exists.

A peripheral collar 86 is moulded integrally with the outer peripheral face of the attachment part 31. A retaining ring 88 of a swivelling device, denoted as a whole by reference numeral 90, for the charge joint part 20 is mounted with clearance between the collar 86 and the region of the cover plate 58 projecting radially beyond the attachment part 31. The charge joint part 20 is guided rotatably in the retaining ring 88 around the axis of rotation 24 of the bottle.

A swivelling arm 92 is moulded integrally with the retaining ring 88. The swivelling arm 92 is disposed downwardly, substantially parallel to the axis of rotation 24 of the bottle. At its free end it is mounted swivellably about the swivel axis 26 to a stationary frame (not shown).

The powder channel 29, after passing through an opening 93 which leads to the funnel receptacle of the housing part 54, continues and extends coaxially with the axis of rotation 24 of the bottle.

The powder channel 29 passes through a cylindrical plug-receiving chamber 94 of the shut-off tap 30, which chamber 94 is formed in the tap housing part 60 and lies on a horizontal axis of rotation 100 of the plug, which intersects the axis of rotation 24 of the bottle perpendicularly and is disposed perpendicularly to the swivel axis 26. However, the axis of rotation 100 may also run obliquely with respect to the axis of rotation 24 of the bottle and/or to the swivel axis 26.

On the side oriented away from the powder bottle 14, the receiving chamber 94 and the corresponding region of the cover plate 58 are open. From there a plug 98 of the shut-off valve 30 is introduced into the receiving chamber 94.

The axis of the plug 98 corresponds to the axis of rotation 100. The end edges of the plug 98 are chamfered conically or in a rounded manner. The plug 98 cooperates at both ends with sliding sealing elements 108 which are mounted on both sides thereof with a sliding fit in the receiving chamber 94 and which permit simple rotation about the axis of rotation 100 and at the same time define control openings of the tap.

The various parts of the tap are secured, from the open lower side, by a retaining part 120 and a spring ring 102.

A connection piece 104 is moulded integrally with the lower side of the cover plate 58.

A through-opening 103 of the retaining part is surrounded by an O-ring seal 106 which seals the retaining part 120 with respect to the lower sliding sealing element 108.

The plug 98 has a continuous passage 99 extending radiantly between two of its circumferential sides.

With the shut-off tap 30 open, as shown in FIG. 1, the axis of the passage 99 is disposed coaxially with the axis of rotation 24 of the bottle and connects the through-opening 93 in the funnel receptacle of the mounting plate 56 to the through-opening 103 in the retaining part 120.

With the shut-off tap 30 closed, the axis of the passage 99 is disposed perpendicularly to the axis of rotation 24 of the bottle, and the passage 99 no longer connects the through-openings 93 and 103.

A drive shaft 110 for the plug 98, coaxial with the axis of rotation 100, runs in a radial bearing bush 112 of the circumferential wall of the tap housing part 60. The drive shaft 110 engages non-rotatably in a receptacle in the left-hand end face of the plug 98. The free end of the drive shaft 110 projects from the bearing bush 112 into the annular chamber 78.

A gear wheel 114 is mounted on the free end of the drive shaft 110. A circumferential section of the gear wheel 114 extends downwardly through a gap 116 in the cover plate 58. The corresponding teeth of the gear wheel 114 cooperate with corresponding teeth of a segment of a toothed ring which is provided on the upper side of the disc part 118.

The disc part 118 has at its centre a circular opening 105 the internal diameter of which corresponds to the external diameter of the connection piece 104, so that the latter can be inserted therein. The edge of the opening 105 oriented towards the charge joint part 20 is chamfered and contributes to delimiting the above-mentioned annular inlet chamber 66.

On the right-hand side in the drawing, a plunger pin arrangement 130 acts between the cover plate 58 and the disc part 118. Acting between these two parts is a latching ball 132, located radially between the gear wheel 114 and at the axis of rotation 24 of the bottle, which latching ball latches when the shut-off tap 30 is open.

On its side oriented away from the charge joint part 20, the disc part 118 adjoins centrally, an at-first circular-cylindrical, and then frustoconical delivery housing part 120, in which the powder channel 29 is continued. The delivery housing part 120 has at the bottom an outlet opening 122 at which the powder channel 29 ends.

Fixing eyes 126 are moulded integrally with the delivery housing part 120 on the outside.

A fluidizing gas supply tube 124 lead into the annular inlet chamber 66. The fluidizing gas supply tube 124 is connected at its free end to a fluidizing gas supply (not shown).

The outside of the delivery housing part 120 has a plurality of steps. On the second step from the top, the delivery housing part 120 has an external screw thread with which it is screwed into a connection piece 128 of the powder conduit 16.

The feed device 10 operates as follows:

Before a new powder bottle is attached, the shut-off tap 30 is closed by rotating the empty powder bottle 14 about its axis of rotation 24. The charge joint part 20 is then rotated anticlockwise through 180° about the swivel axis 26. As this happens, the delivery joint part 22 remains firmly connected to the stationary powder conduit 16.

In order to attach a full powder bottle 14, the feed device 10 is now in the exchange position (not shown), in which the attachment socket 33 faces downwards and the connection piece 104 faces upwards.

A new, full powder bottle 14 is now screwed into the attachment socket 33 from below, with its container opening 19 oriented upwardly. The container opening 19 is thus located above the filling line 53, so that powder 12 cannot escape from the powder bottle 14.

As the charge joint part 20 is then swivelled back to the working position, shown in the drawing, in which the attached powder bottle 14 is swivelled with it, powder 12 is prevented from escaping through the powder conduit 29 before the charge joint part 20 has been connected sealingly to the delivery joint part 22, because the shut-off tap 30 is closed.

As the working position is approached, the connection piece 104 moves into the central opening 105 of the disc part 118. As soon as the cover plate 58 abuts sealingly against the disc part 118, the latching pin arrangement 130 latches.

As is shown in FIG. 1, the powder bottle 14 is now positioned vertically above the powder conduit 16, with its container opening 19 facing downwards.

The supply of fluidizing gas is then started, so that fluidizing gas flows through the fluidizing gas supply tube 124, the annular inlet chamber 66, the fluidizing gas connecting channel 64, the annular inlet chamber 62 and the fluidizing gas connecting channels 44, into the container opening 19 of the powder bottle 14. In the latter the fluidizing gas has the effect that powder 12 is loosened and made flowable. Powder 12 is thereby prevented from forming lumps or even clogging the container opening 19, the inlet opening 38 or the powder channel 29.

The fluidizing gas flows through the powder bottle 14 from the container opening 19 to the base of the powder bottle 14, through the filter 52 and into the suction lance 50.

From the suction lance 50 the fluidizing gas flows through the channel section 49, the annular outlet chamber 68 and the outlet tube 76 into the large annular chamber 78, and from there through the outlet tube 80 and the fluidizing gas discharge channel 84 into the environment.

The powder bottle 14, and with it the charge joint part 20, is then rotated through approximately 60° about the axis of rotation 24 of the bottle. As this happens, the gear wheel 114 runs along the toothed segment of the disc part 118, whereby the drive shaft 110, and with it the plug 98, is rotated and the shut-off tap 30 is opened.

As soon as the shut-off tap 30 is open, the ball of the ball latch 132 latches into the latching hole in the cover plate 58.

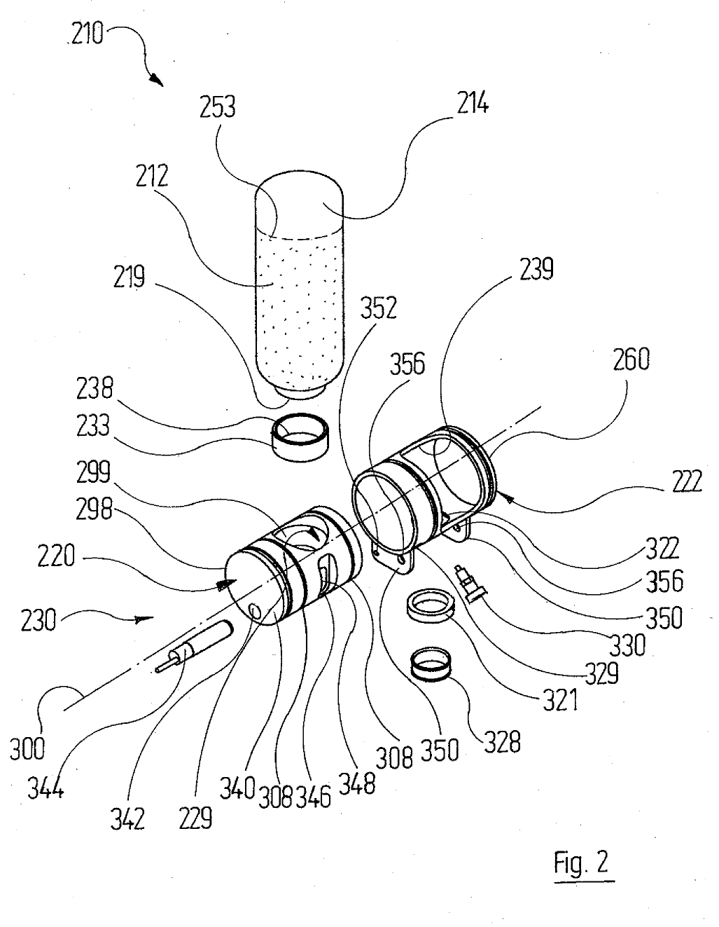

FIGS. 2 to 9 show a second exemplary embodiment of a feed device for transferring powder from a powder bottle to a powder conduit.

Parts of the device which correspond functionally to parts already described are provided with reference numerals increased by the number 200, and are described again only if this is relevant to the operation of the device.

The powder bottle 214 is fixed directly and detachably to the plug 298 of a shut-off tap 230 via an attachment socket 233.

The attachment socket 233 forms an inlet opening 238 of a powder channel denoted as a whole by 229.

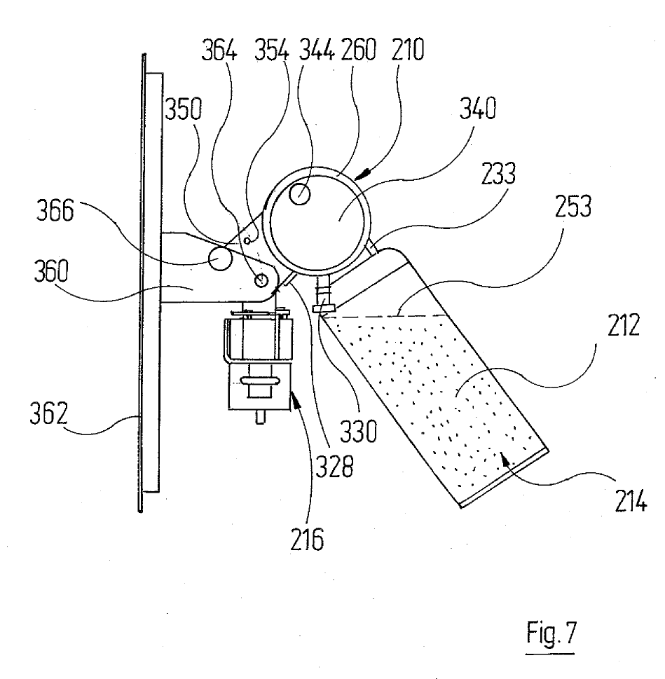

A tap housing part 260 of the shut-off tap 230 forms part of a delivery joint part 222 which is connected to the powder conduit 216, as shown in FIG. 7.

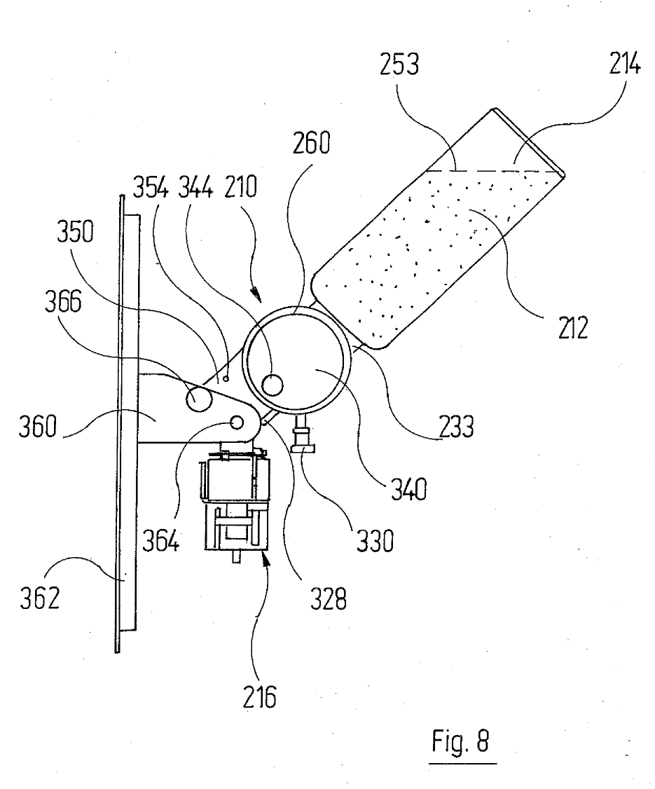

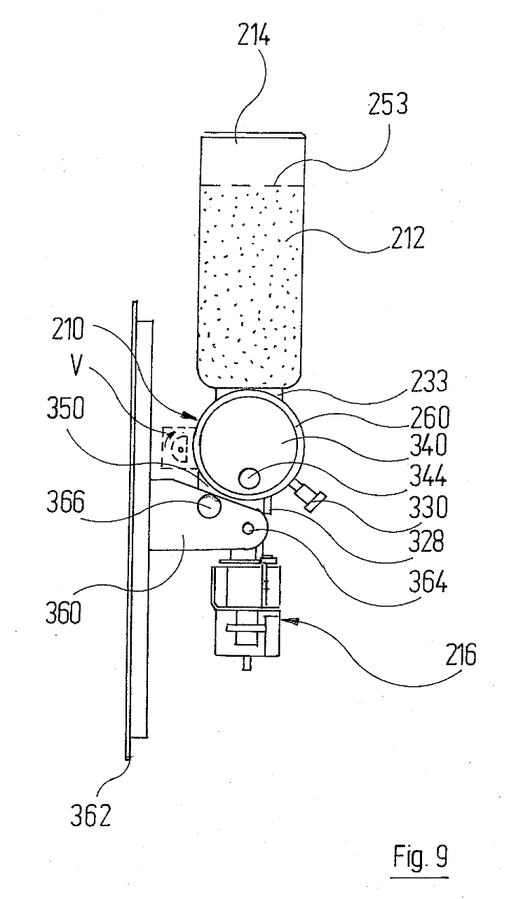

In this feed device 210, at the same time as the powder bottle 214 is swivelled about a horizontal axis of rotation 300 from the exchange position (FIG. 7) via an intermediate state (FIG. 8) to the working position (FIG. 9), the plug 298 in the tap housing part 260 is rotated about the axis of rotation 300 and the shut-off tap 230 is thereby opened.

A passage 299 passes through the plug 298 perpendicularly to the axis of rotation 300.

The passage 299 has in its longitudinal direction three regions having different profiles, as can be seen in particular in FIGS. 5 and 6. A first region faces towards the powder bottle 214. The attachment socket 233, in the form of an annular PTFE part, is bonded into this first region. Adjoining the first region is a funnel-shaped, inwardly tapering second region which adjoins a third, cylindrical region shortly before the axial centre of the passage 299. The diameter of the third region is smaller than the diameter of the first region. A ring 321 of PTFE is bonded into the third region of the passage 299.

The plug 298 forms part of a charge joint part 220 for the powder bottle 214, which charge joint part 220 also includes the attachment socket 233.

The plug 298 fits into the hollow-cylindrical tap housing part 260, which is open at one end face (at the front in FIG. 2). The axes of the plug 298 and of the tap housing part 260 are coaxial with the axis of rotation 300.

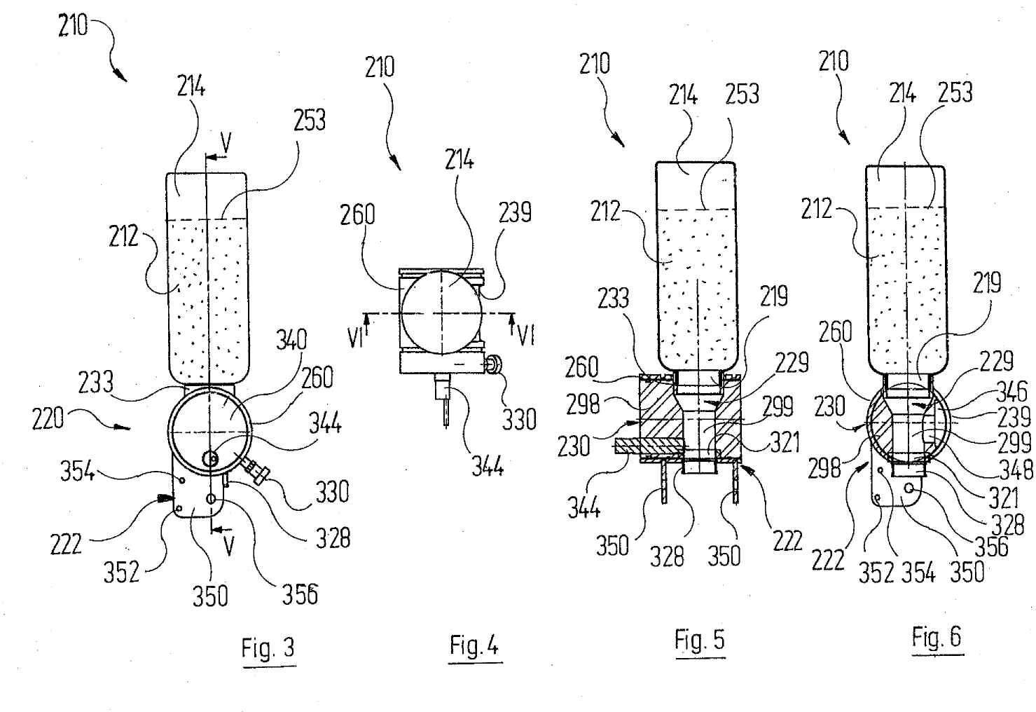

The circumferential wall of the tap housing part 260 has an elongated hole 239 which extends in the circumferential direction over a quarter of the circumference of the tap housing 260, which elongated hole 239 is at the top in the working position of the feed device 210, as shown in the FIGS. 3 to 6 and 9.

The dimension of the elongated hole 239 in the direction of the axis of rotation 300 is somewhat greater than the external diameter of the attachment socket 233, so that the latter runs in the elongated hole 239 as the plug 298 is rotated about the axis of rotation 300.

In the working position, the shut-off tap 230 is open. In that case the passage 299 of the plug 298 is open towards an outlet opening 322 in the lower circumferential side of the tap housing part 260, so that the powder 212 can pass through the powder channel 229.

In the exchange position (FIG. 7) the plug 298 is rotated relative to the tap housing part 260 in such a way that the end of the passage 299 facing away from the inlet opening 238 is closed by the inner wall of the tap housing part 260.

A hollow-cylindrical connecting piece 328 for the powder conduit 216 is inserted in the outlet opening 322.

A disc-shaped end cap 340, which is flush with the circumferential surface of the plug 298 on the outside, is fixed to the end face of the plug 298 corresponding to the open, front end face of the tap housing part 260. A bore 342 passing through the end cap 340 and the end face of the plug 298 parallel to the axis of rotation 300 leads into the passage 299.

A sensor 344 with which the presence of powder 212 in the passage 299 can be detected is arranged in the bore 342. The sensor 344 is connected via signal lines (not shown) to a warning and/or display device (not shown) with which an optical and/or acoustic signal is emitted as soon as powder 212 is no longer present in the passage 299. This is the case, for example, if the powder bottle 214 is empty or the container opening 219 is clogged.

The warning and/or display device may also be connected to a central control device or may form part of such a device, with which a dust-application apparatus can be stopped as soon as the passage 299 no longer contains powder 212.

The plug 298 has on the outside an elongated vertical groove 346 which extends parallel to the axis of the passage 299. The passage 299 and the groove 346 are connected to one another via a through-opening 348 which is elongated in the direction of the axis of the passage 299.

In addition, annular seals 308 are fitted on the outside of the plug 298 on both sides of the passage 299.

In front of the region sealed by the annular seals 308, the circumferential wall of the tap housing part 260 also has in the region of the end cap 340 a through-bore 329 shown in FIG. 2. The bore 329 serves as a trap for a locking pin 330. In the working position of the feed device 210 (FIG. 3), the bore 329 is located in the bottom right-hand quarter of the circumferential wall of the tap housing part 260, obliquely below the elongated hole 239.

A corresponding locking hole, not shown in FIGS. 2 to 9, is provided in the plug 298. The locking pin 330 latches into the locking hole in the working position.

In order to switch from the working position shown in FIG. 9 to the exchange position shown in FIG. 7, the locking pin 330 must first be withdrawn from its locking hole. Only then can the plug 298 be rotated relative to the tap housing part 260 about the axis of rotation 300.

Two flat retaining brackets 350, extending perpendicularly to the axis of rotation 300, are bonded to the outer circumferential face of the tap housing part 260 which is oriented towards the powder conduit 216, on both sides of the outlet opening 322 in the axial direction. The retaining brackets 350 may also be connected to the housing part 260 in another manner. They may also be moulded integrally thereon.

Each retaining bracket 350 has three holes 352, 354 and 356, which are visible, in particular, in FIGS. 3 and 6. The mutually corresponding holes 352, 354 and 356 in the two retaining brackets 350 are aligned with one another when viewed in the direction of the axis of rotation 300 (side view of FIG. 3).

The centres of the two holes 352 and 354 lie on a circular line around the centre of the hole 356, which is provided for a pivot pin.

In the working position, a straight line through the centres of the two opposed holes 356 intersects the vertical axis of the powder bottle 214 and of the powder channel 229. In FIG. 3 this axis coincides with the section line V-V.

As shown in FIGS. 7 to 9, the feed device 210 is mounted swivellably via the retaining brackets 350 on a retaining element 360 made of flat material folded to a U-shape in top view, the side-pieces of which are located side-by-side in a horizontal plane. The U-shaped retaining element 360 is fixed by its closed side to a vertical frame 362. Alternatively, it may be fixed to a wall. The retaining brackets 350 are arranged between the side-pieces of the retaining element 360.

The side-pieces of the retaining element 360 each have a pin hole 364 corresponding to the holes 356. A pin or a screw, with which the retaining brackets 350 are mounted swivellably to the side-pieces of the retaining element 360, extends through the holes 356 and the corresponding pin holes 364.

In addition, each side-piece of the retaining element 360 has a locking pin 366 which passes through the side-piece. The locking pin 366 can be operated from outside and can engage under spring-loading selectively in one of the locking holes 352 and 354, and can thus fix the orientation of the retaining brackets 350 relative to the side-pieces of the retaining element 360.

The locking pins 366 are so positioned that in the exchange position (FIG. 7) they latch into the respective lower locking holes oriented away from the tap housing part 260. The tap housing part 260 is then located obliquely above the powder conduit 216, with the attachment socket 233, and therefore the inlet opening 238, being oriented obliquely downwards.

The powder bottle 214 is thus screwed or fitted into the attachment socket 233 from below, with its upwardly-directed container opening 219 located above the filling line 253, without powder 212 escaping.

The powder bottle 214, with the plug 298, is then swivelled upwardly through 90° about the axis of rotation 300, until the locking pin 330 latches into the locking hole in the plug 298 in the intermediate state (FIG. 8). The outlet opening 322, the passage 299 and the inlet opening 238 are now aligned, and the powder channel 229 is now open.

The feed device 210 is then swivelled upwards through a further 30° about the pivot pin 264, until the axes of the powder bottle 214 and of the powder channel 229 are vertical. To this end, the locking pins 360 must first be withdrawn from the locking holes 352.

When the working position is reached (FIG. 9), the locking pins 366 latch into the upper locking holes 354. Powder 212 now falls vertically from the powder bottle 214 through the powder channel 229 and into the powder conduit 216.

With all the above-described exemplary embodiments of a feed device 10; 210, the following modifications, inter alia, are possible:

The feed devices are not restricted to use in the metering devices 18 of powder application equipment. Rather, they can be used wherever a powdery medium is to be transferred from a powder container into a powder conduit.

All the feed devices can be used both with and without fluidizing device or sensors for detecting the powdery medium.

As indicated in FIG. 9, the feed device may be coupled mechanically to a vibrator V which, in the exemplary embodiment illustrated, is arranged on the outside of the charge joint part 20. It is shown schematically as an unbalanced mass vibration generator, but may also be an electromagnetic vibrator or a magnetorestrictive or piezoelectric vibrator.

The vibrator V prevents the powder channel 229 from being clogged, or significant residual quantities from remaining therein.

Instead of the powder bottles 14; 214, other powder containers may be used.

Furthermore, it is not essential that the powder bottles taper conically inwards towards the container opening. The transition to the container opening may also narrow in a different way.

Although certain feeding devices have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A feed device for conveying a powdery medium from a powder container into a powder conduit, with a powder channel which connects the powder container and the powder conduit and which, in a working position, is arranged with a vertical component of an axis of the powder channel above a charge end of the powder conduit,
wherein the powder channel has a joint unit which in turn comprises:
a charge joint part to which the powder container is connected detachably in a sealed manner, and
a delivery joint part for connecting the powder channel in a sealed manner to the charge end of the powder conduit; and
wherein a displacement travel of the joint unit is sufficiently large for a filling level of the powder container to be located below an opening of the powder container in a lowered exchange position.

2. A feed device according to claim 1, wherein a blocking means for the powder channel is arranged in the joint unit, which blocking means can be actuated by rotation or swivelling of the charge joint part with respect to the delivery joint part.

3. A feed device according to claim 1, wherein the powder container narrows, in particular conically, towards its opening, so that it has substantially the shape of a cylindrical-conical bottle.

4. A feed device according to claim 1, wherein the powder channel is oriented substantially vertically in the working position.

5. A feed device according to claim 1, wherein the powder container is connectable to the charge joint part via a plug-in connection, a screw connection or a bayonet connection.

6. A feed device according to claim 1, wherein a blocking means has a rotatable plug which is connected non-rotatably to one of the joint parts, and has a tap housing which is connected non-rotatably to the other of the joint parts.

7. A feed device according to claim 6, wherein the plug is connected to a transmission, in particular a gear transmission, which converts a swivelling motion of the charge joint part relative to the delivery joint part about an axis of rotation of the joint into a rotation of the plug about an axis of rotation of the tap which is inclined, in particular at 90°, to the axis of rotation of the joint.

8. A feed device according to claim 6, wherein the plug, together with the tap housing, at the same time forms a joint of the joint unit.

9. A feed device according to claim 1, further comprising:
a fluidizing device for fluidizing the powdery medium in the powder container, which fluidizing device in turn preferably has a fluidizing gas supply which leads into the interior of the powder container, and preferably includes a fluidizing gas discharge means, in particular a suction lance, which leads out of the powder container.

10. A feed device according to claim 1, wherein a sensor for detecting the presence of powdery medium is arranged in the powder channel.

11. A feed device according to claim 1, wherein the powder channel is coupled to a vibrator.

12. A feed device according to claim 1, wherein a blocking means for the powder channel is arranged in the joint unit, which blocking means can be actuated by rotation and swivelling of the charge joint part with respect to the delivery joint part.

13. A feed device according to claim 2, wherein the powder container narrows, in particular conically, towards its opening, so that it has substantially the shape of a cylindrical-conical bottle.

14. A feed device according to claim 6, wherein the rotatable plug is connected non-rotatably to the charge joint part, and the tap housing is connected non-rotatably to the delivery joint part.

15. A feed device according to claim 7, wherein the plug, together with the tap housing, at the same time forms a joint of the joint unit.
